(19) United States
(12) Patent Application Publication
(10) Pub. No.: US 2024/0048497 A1
(43) Pub. Date: Feb. 8, 2024

(54) COMMUNICATION DEVICE, COMMUNICATION METHOD, AND RECORDING MEDIUM

(71) Applicant: Mitsubishi Electric Corporation, Tokyo (JP)

(72) Inventors: Yoshiki MAKIMURA, Nagoya-shi, Aichi (JP); Norihiro TSUCHIYA, Tokyo (JP)

(73) Assignee: Mitsubishi Electric Corporation, Tokyo (JP)

(21) Appl. No.: 18/265,675

(22) PCT Filed: Apr. 26, 2021
(86) PCT No.: PCT/JP2021/016668

§ 371 Date: Jun. 7, 2023

(51) Int. Cl. H04L 47/28

(52) U.S. Cl. CPC H04L 47/28

(57) ABSTRACT

A communication device includes a communication module to communicate with a first device by at least transmitting or receiving first data in a first data segment included in multiple time segments defined by a shared time shared with the first device and corresponding to a type of the first data, a reception module to receive second data transmitted from a second device independently of the time segments, a relay module to relay, when a destination of the second data includes the first device, the second data to be transmitted in a second data segment being a time segment corresponding to a type of the second data, and transmission module to transmit in an instruction segment, to the second device, instruction data to specify a length of time for which transmission of the second data is suspended. The instruction segment is a time segment for transmitting the instruction data.

### TECHNICAL FIELD

The present disclosure relates to a communication device, a communication method, and a program.

### BACKGROUND ART

Facilities such as factories operate using an industrial network for controlling multiple devices. The industrial network involves multiple devices operating in cooperation accurately based on information transmitted in real time between the devices. Communication schemes for integrating such an industrial network with a general-purpose information network that may not focus on real time performance have been standardized and have received attention. An example of such communication schemes is IEEE 802.1 Time-Sensitive Networking (TSN). IEEE 802.1 TSN is hereafter referred to as the TSN standards.

However, known devices may not be readily compliant with the above communication scheme. Thus, techniques have been developed to use devices that do not have communication capabilities in accordance with the above communication scheme together with devices with such communication capabilities (see, for example, Patent Literature 1).

Patent Literature 1 describes a switching hub that maintains functionality produced with a buffer when the switching hub is on a network including devices that are not compliant with the TSN standards. More specifically, under the TSN standards, time-division provides time for low-level communication and time for high-level communication. A switching hub may hold, in a built-in buffer, data transmitted from devices that are not compliant with the TSN standards for an appropriate communication time. Such data may occupy the space in the buffer. In contrast, with the technique described in Patent Literature 1, data determined to be a valued packet in a switch engine is transferred to a central processing unit (CPU) and stored into a buffer memory, whereas data determined to be a normal packet less valuable than the valued packet is transferred to a destination port without being transferred to the CPU. This reduces the burden on the buffer memory.

### CITATION LIST

### Patent Literature

Patent Literature 1: Unexamined Japanese Patent Application Publication No. 2020-017877

### SUMMARY OF INVENTION

### Technical Problem

With the technique described in Patent Literature 1, the CPU further verifies whether the packets received from the switch engine are to be discarded. When valued packets transmitted from devices that are not compliant with the TSN standards occur frequently in a short period of time, the CPU discards some of such valued packets. When normal packets that are not valued packets are received but the buffer memory lacks space, the normal packets are also discarded. This causes the issue of data loss.

In response to the above issue, an objective of the present disclosure is to reduce data loss in a network including both a device with time-division communication capabilities and a device without time-division communication capabilities.

### Solution to Problem

To achieve the above objective, a communication device according to an aspect of the present disclosure is a communication device for communicating with a first device and a second device. The communication device includes communication means for communicating with the first device by at least transmitting first data to the first device or receiving the first data from the first device in a first data segment included in a plurality of time segments defined by a shared time shared with the first device and being a time segment corresponding to a type of the first data, reception means for receiving second data transmitted from the second device independently of the plurality of time segments, relay means for relaying, when a destination of the second data received by the reception means includes the first device, the second data to be transmitted to the first device in a second data segment included in the plurality of time segments and being a time segment corresponding to a type of the second data, and transmission means for transmitting in an instruction segment included in the plurality of time segments, to the second device, instruction data to specify a length of time for which transmission of the second data is suspended to instruct the second device to suspend transmission of the second data. The instruction segment is a time segment for transmitting the instruction data. The length of time specified by the instruction data is equal to or greater than a length of time from when the second device suspends transmission of the second data in accordance with the instruction data to when at least a part of a time segment immediately following the instruction segment and preceding the second data segment elapses.

### Advantageous Effects of Invention

In the structure according to the above aspect of the present disclosure, the transmission means transmits, to the second device, instruction data to instruct the second device to suspend transmission of the second data in the instruction segment. The length of time specified by the instruction data is equal to or greater than a length of time from when the second device suspends transmission of the second data in accordance with the instruction data to when at least a part of a time segment immediately following the instruction segment and preceding the second data segment elapses. The second device thus suspends transmission of the second data in accordance with the instruction data in at least a part of the time segment preceding the second data segment, and can transmit the second data in the second data segment. This can reduce an excess load caused by temporarily holding the second data for transmission in appropriate time segments in the communication device. The communication device can thus reduce data loss in the network including both a device with time-division communication capabilities and a device without time-division communication capabilities.

### BRIEF DESCRIPTION OF DRAWINGS

FIG. 1 is a block diagram of a communication system according to Embodiment 1;

FIG. 2 is a block diagram of a network device according to Embodiment 1, illustrating the hardware configuration;

FIG. 3 is a schematic diagram describing communication using time-division in Embodiment 1;

FIG. 4 is a diagram describing buffering in the communication system according to Embodiment 1;

FIG. 5 is a functional block diagram of a communication device according to Embodiment 1;

FIG. 6 is a diagram describing suspension of transmission of second data in Embodiment 1;

FIG. 7 is a table illustrating the correspondence between a time segment and a communication type corresponding to the time segment in Embodiment 1;

FIG. 8 is a flowchart of a reception process performed by the communication device according to Embodiment 1;

FIG. 9 is a diagram describing buffering in the communication device according to Embodiment 1;

FIG. 10 is a flowchart of an instruction process performed by the communication device according to Embodiment 1;

FIG. 11 is a diagram describing transmission of instruction data performed by the communication device according to Embodiment 1;

FIG. 12 is a functional block diagram of a communication device according to Embodiment 2;

FIG. 13 is a diagram describing calculation of a transmission delay in Embodiment 2;

FIG. 14 is a diagram describing suspension of transmission of second data in Embodiment 2;

FIG. 15 is a diagram describing different lengths of time slots in Embodiment 2;

FIG. 16 is a diagram describing suspension of transmission of second data in Embodiment 3;

FIG. 17 is a diagram describing different times for transmission of instruction data in Embodiment 3;

FIG. 18 is a diagram describing suspension of transmission of second data in Embodiment 4;

FIG. 19 is a table illustrating the correspondence between a time segment and a communication type corresponding to the time segment in Embodiment 4;

FIG. 20 is a block diagram of a communication system according to Embodiment 5;

FIG. 21 is a diagram describing suspension of transmission of second data in Embodiment 5; and

FIG. 22 is a diagram describing suspension of transmission of second data in a modification.

### DESCRIPTION OF EMBODIMENTS

A communication device 100 according to one or more embodiments of the present disclosure is described below in detail with reference to the drawings.

### Embodiment 1

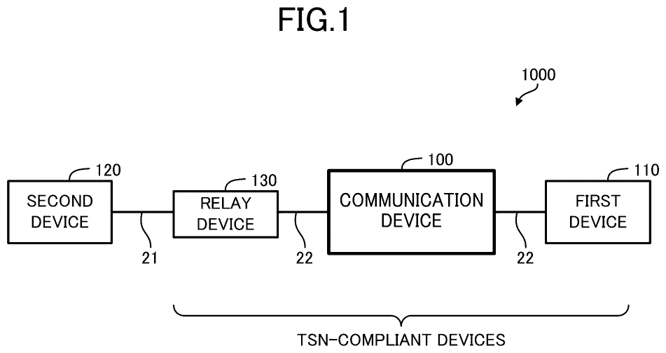

As illustrated in FIG. 1, the communication device 100 according to the present embodiment is connected to a first device 110 and a second device 120 with a network for mutual communication. The communication device 100, the first device 110, the second device 120, and a relay device 130 are included in a communication system 1000. The communication system 1000 corresponds to a part of a factory automation (FA) system installed at a factory. The FA system may be, for example, a manufacturing system, an inspection system, a machining system, or any other system. The communication system 1000 implements at least a part of pseudo communication capabilities with time-division by causing devices that have no communication capabilities with time-division to temporarily suspend transmission of data.

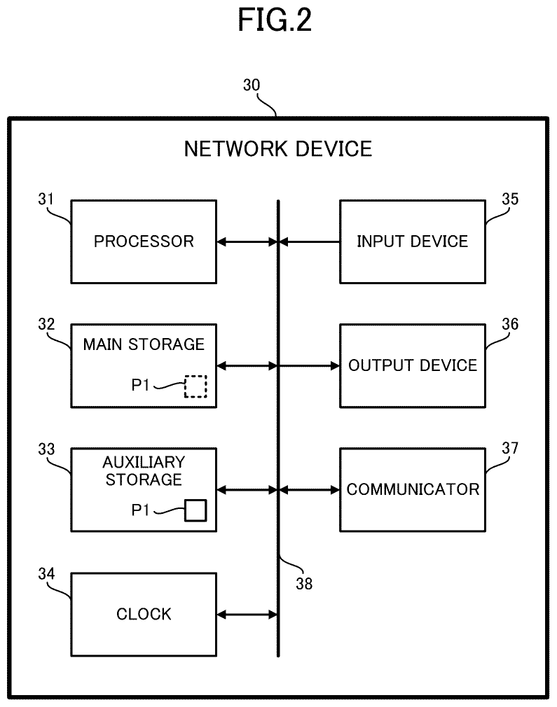

The communication device 100, the first device 110, the second device 120, and the relay device 130 each have a common hardware configuration illustrated in FIG. 2. The communication device 100, the first device 110, the second device 120, and the relay device 130 are each referred to as a network device 30 as illustrated in FIG. 2 without distinction. The network device 30 includes, as hardware components, a processor 31, a main storage 32, an auxiliary storage 33, a clock 34, an input device 35, an output device 36, and a communicator 37. The main storage 32, the auxiliary storage 33, the clock 34, the input device 35, the output device 36, and the communicator 37 are connected to the processor 31 with an internal bus 38.

The processor 31 includes a central processing unit (CPU) or a micro processing unit (MPU) that is an integrated circuit. The processor 31 executes a program P1 stored in the auxiliary storage 33 to implement the various functions of the network device 30 and perform the processing described later.

The main storage 32 includes a random-access memory (RAM). The main storage 32 stores the program P1 loaded from the auxiliary storage 33. The main storage 32 is used as a work area by the processor 31.

The auxiliary storage 33 includes a nonvolatile memory, typically an electrically erasable programmable read-only memory (EEPROM) and a hard disk drive (HDD). The auxiliary storage 33 stores, in addition to the program P1, various sets of data used in the processing performed by the processor 31. The auxiliary storage 33 provides data to be used by the processor 31 to the processor 31 as instructed by the processor 31 and stores data provided by the processor 31.

The clock 34 includes, for example, a clock generator including a quartz resonator, a silicon resonator, a quartz oscillator, or another oscillator circuit. The clock 34 generates a clock signal based on a clock generated by the clock generator and outputs the clock signal. The clock signal includes a clock pulse, and is used by the processor 31 to measure time by counting the number of times the clock pulse rises using a built-in hardware device or through software processing.

The input device 35 includes input devices, typically input keys and a pointing device. The input device 35 acquires information input by the user of the network device 30 and provides the acquired information to the processor 31.

The output device 36 includes output devices, typically a light-emitting diode (LED), a liquid crystal display (LCD), and a speaker. The output device 36 presents various items of information to the user in accordance with an instruction from the processor 31.

The communicator 37 includes a network interface circuit to transmit and receive Ethernet frames to and from external devices. The communicator 37 receives a signal from an external device and outputs data carried by the signal to the processor 31. The communicator 37 also transmits a signal carrying data output from the processor 31 to an external device. Although FIG. 2 illustrates the single communicator 37, the network device 30 may include multiple communicators 37 for connection to different transmission lines.

Referring back to FIG. 1, the communication device 100, the first device 110, and the relay device 130 are TSN-compliant devices that are compliant with the TSN standards. For example, the communication device 100 and the first device 110 are network units each included in a programmable logic controller (PLC) that is an industrial control device, and the relay device 130 is a switching hub. The communication device 100, the first device 110, and the relay device 130 communicate with one another in accordance with the TSN standards through a communication channel 22.

The second device 120 is not compliant with the TSN standards. The second device 120 is, for example, an industrial personal computer (IPC) connected to the relay device 130 that serves as a switching hub through a communication channel 21, a PLC that is not compliant with the TSN standards, or a unit included in the PLC, an actuator or a robot to be controlled by the PLC, a sensor device including a sensor, or another device. In the example described below, the second device 120 that is not compliant with the TSN standards performs IP communication.

An overview of the communication in accordance with the TSN standards performed by the communication device 100, the first device 110, and the relay device 130 is described below.

The communication device 100, the first device 110, and the relay device 130 that are TSN-compliant devices can operate on synchronized time through the communication channel 22. In detail, each of the TSN-compliant devices shares time with the other devices in accordance with a synchronous protocol. The synchronous protocol is used to synchronize the devices on a communication network with high accuracy. With, for example, IEEE802.1AS used as the synchronous protocol, a grandmaster corresponding to one node on the network periodically distributes an accurate reference clock through the communication network. When the data is transmitted back to and from the grandmaster from a slave corresponding to another node, a communication delay is measured. The slave acquires a reference clock by correcting this communication delay. Thus, the time with the communication delay being corrected is shared.

Time sharing and synchronization among multiple devices refer to synchronization of clocks included in the respective devices. When the clocks in the respective devices measure the same time and each share the measured time with one another, the devices are synchronized. The time shared between the devices is hereafter referred to as a shared time.

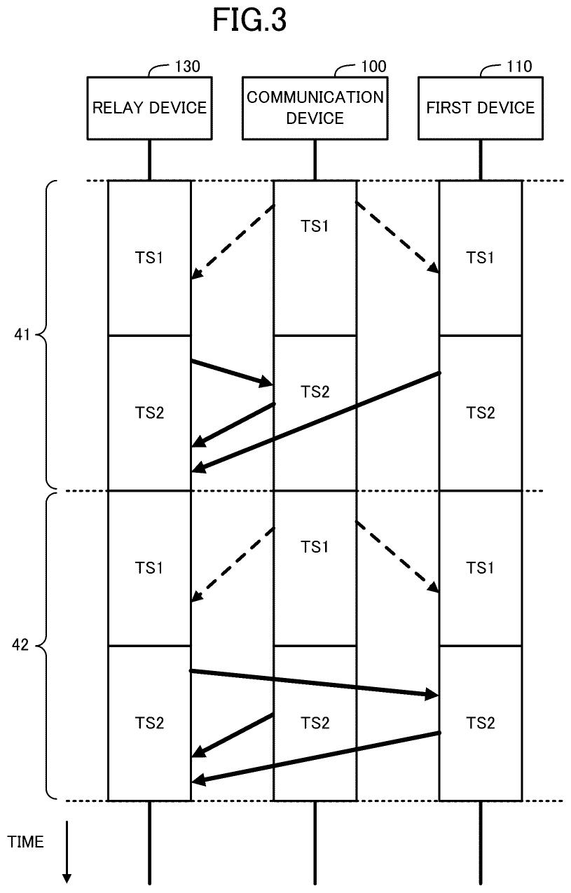

Each TSN-compliant device transmits or receives data at the shared time based on a predetermined schedule. More specifically, as illustrated in FIG. 3, the communication device 100, the first device 110, and the relay device 130 perform communication using time-division multiplexing in periods 41 and 42 each with a length predetermined in accordance with the shared time.

The periods 41 and 42 are adjacent to each other. More specifically, the period 42 immediately follows the period 41, with the end time of the period 41 coincident with the start time of the period 42. Although two periods, or the periods 41 and 42, are illustrated in FIG. 3, periods equivalent to the periods 41 and 42 periodically precede the period 41 and follow the period 42.

The periods 41 and 42 each include a time slot TS1 and a time slot TS2 that are adjacent to each other. When the time slots TS1 and TS2 occur in this order in the period 41 as illustrated in FIG. 3, the start time of the time slot TS1 coincides with the start time of the period 41, the end time of the time slot TS1 coincides with the start time of the time slot TS2, and the end time of the time slot TS2 coincides with the end time of the period 41. The time slot TS2 in the period 41 is immediately followed by the time slot TS1 in the period 42.

The time slots TS1 and TS2 are time segments for transmitting different types of predefined data. In detail, the time slot TS1 and the time slot TS2 are defined for performing communication with respective predetermined modes, channels, or protocols. In the time slot TS1, data for synchronizing time with the synchronous protocol is transmitted from the communication device 100 corresponding to a grandmaster to the first device 110 and the relay device 130 corresponding to slaves, as indicated with broken arrows in FIG. 3. In the time slot TS2, internet protocol (IP) communication is performed as indicated with thick arrows in FIG. 3. The periods 41 and 42 have an equal length to allow cyclic communication in each time slot. With each time slot transmitting data of the type corresponding to the time slot, each device at least transmits or receives data, or does not perform communication when no data is to be transmitted.

In communication between the communication device 100 and the second device 120 as illustrated in FIG. 1, the second device 120 without communication capabilities in accordance with the TSN standards transmits data independently of any time slot. Although TSN-compliant devices transmit data of the corresponding type predetermined for each time slot, the second device 120 can transmit data of a type different from the type corresponding to the time slot. The type of data corresponding to the time slot refers to a classification of data that can be relayed within the time slot without buffering when data is relayed in the time slot. The type of data that does not correspond to the time slot refers to a classification of data that involves buffering when data to be relayed to the TSN-compliant device in the time slot is received by another TSN-compliant device.

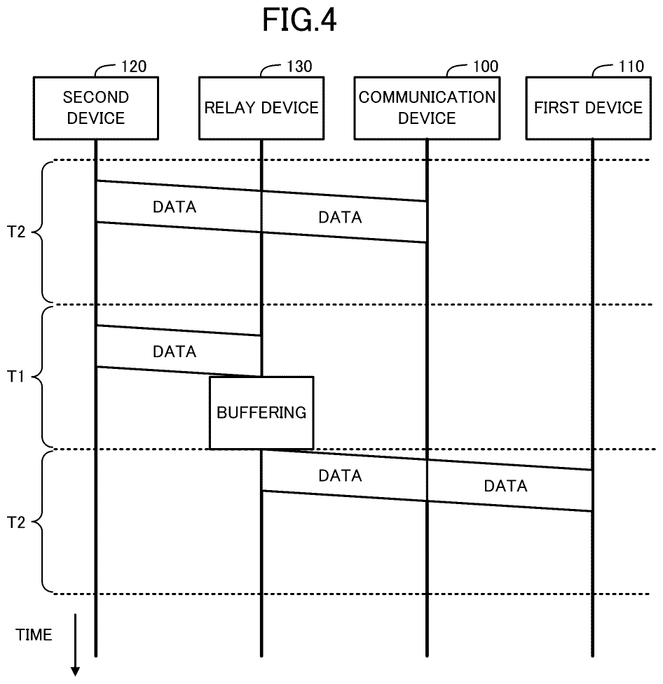

In the example described with reference to an upper portion of FIG. 4, the second device 120 transmits data for IP communication directed to the communication device 100 in a time slot T2 defined for the IP communication. The relay device 130 receives data from the second device 120 and relays the data by transmitting the received data to the communication device 100 in the time slot T2.

In the example described with reference to a lower portion of FIG. 4, the second device 120 transmits IP communication data directed to the first device 110 in a time slot T1. The relay device 130 receives data from the second device 120 in the time slot T1. However, in the time slot T1 that is not a time segment for IP communication, the relay device 130 buffers and temporarily holds the received data and transmits the received data to the communication device 100 in the time slot T2 to relay the data. The communication device 100 receives data from the relay device 130 and relays the data by transmitting the received data to the first device 110 in the time slot T2. Although not illustrated in FIG. 4, when receiving data of a type that does not correspond to the time slot, the communication device 100 relays, similarly to the relay device 130, the data by temporarily buffering the data and then transmitting the data.

When the amount of data to be relayed increases and exceeds the buffer capacity, the data may be discarded and lost. This can cause data loss, known as, for example, frame loss or packet loss. In contrast, the communication device 100 is capable of instructing, before the time slot T1, the second device 120 to suspend transmission of data for a determined period of time.

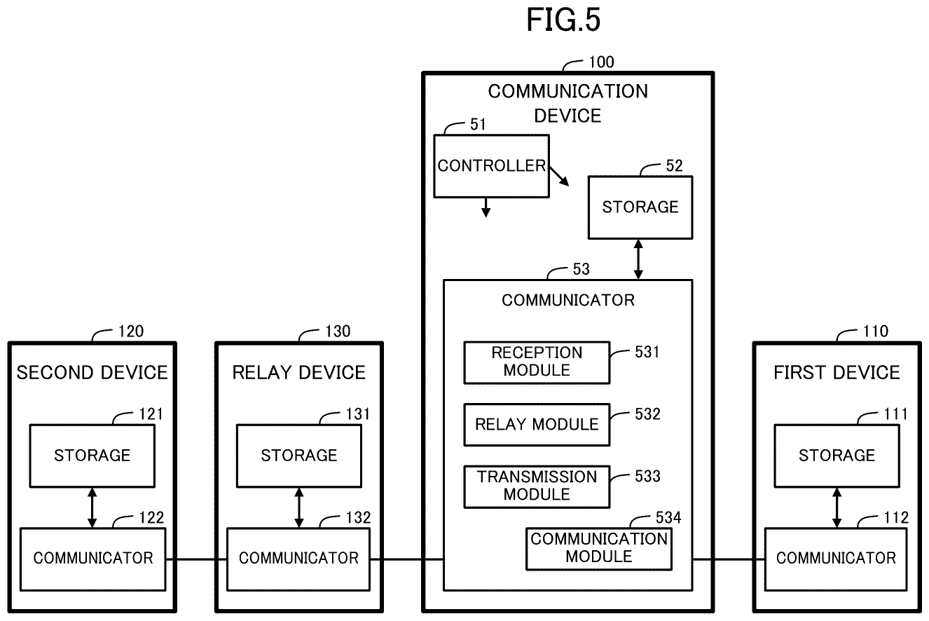

FIG. 5 illustrates the functional components of the communication device 100, the first device 110, the second device 120, and the relay device 130. As illustrated in FIG. 5, the communication device 100 includes, as functional components, a controller 51 that controls the components of the communication device 100, a storage 52 that stores various sets of data, and a communicator 53 that communicates with other devices.

The controller 51 is mainly implemented by the processor 31 included in the communication device 100. The controller 51 controls the storage 52 and the communicator 53 to cause the storage 52 and the communicator 53 to operate in cooperation.

The storage 52 is implemented by at least one of the main storage 32 or the auxiliary storage 33 in the communication device 100. The storage 52 stores data to be transmitted by the communication device 100 to other devices and data received from other devices. The storage 52 may store data that is temporarily held by the communication device 100 in relaying the data.

The communicator 53 is mainly implemented by the processor 31 and the communicator 37 in the communication device 100 operating in cooperation with each other. The communicator 53 transmits and receives data to and from the first device 110 and the relay device 130. The communicator 53 includes a reception module 531 that receives data from the second device 120, a relay module 532 that relays data transmitted from the second device 120, a transmission module 533 that transmits instruction data to instruct the second device 120 to suspend transmission of data, and a communication module 534 that communicates in accordance with the TSN standards.

In the example described below, data transmitted and received by the communication device 100 to and from a TSN-compliant device is referred to as first data, and data transmitted from the second device 120 is referred to as second data. The time slot T1 corresponds to an example of a first data segment being a time segment corresponding to a type of the first data. The time slot T2 corresponds to an example of a second data segment being a time segment corresponding to a type of the second data. The reception module 531 corresponds to an example of reception means for receiving the second data transmitted from the second device 120 independently of any time segment. The relay module 532 corresponds to an example of relay means, in the communication device 100, for relaying the second data to be transmitted to the first device in the second data segment when a destination of the second data received by the reception means includes the first device. The communication module 534 corresponds to an example of communication means, in the communication device 100, for communicating with the first device by at least transmitting first data to the first device or receiving the first data from the first device in the first data segment included in multiple time segments defined by the shared time shared with the first device.

Instruction data transmitted by the transmission module 533 includes a specified value indicating the length of time for which transmission of data is to be suspended. Upon receiving the instruction data, the second device 120 suspends transmission of data for the length of time specified with the instruction data from when the instruction data is received. The instruction data is, for example, a PAUSE frame as specified in IEEE802.3x. The PAUSE frame is data used by a device that receives an Ethernet frame to instruct the source device to suspend transmission for a period of time when the amount of data is to exceed the buffer capacity.

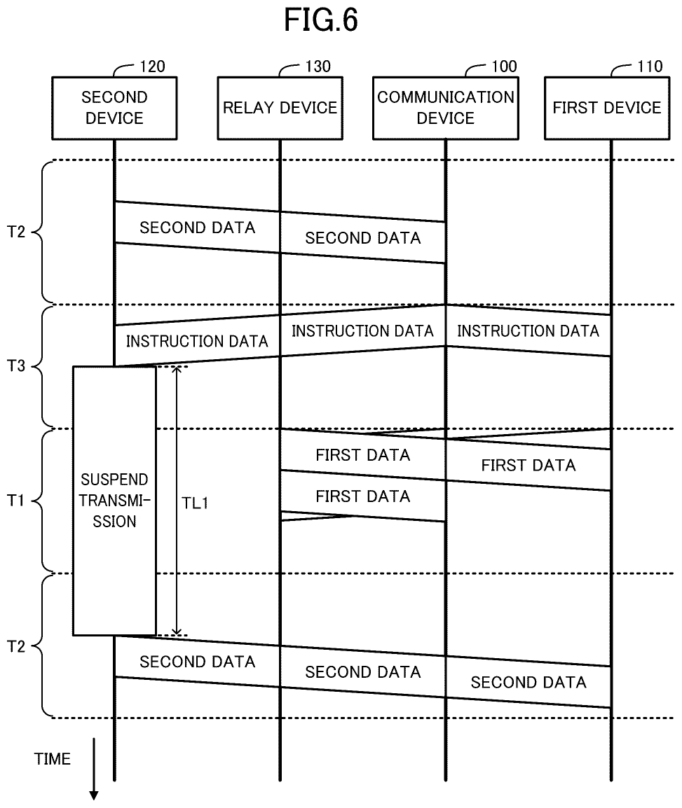

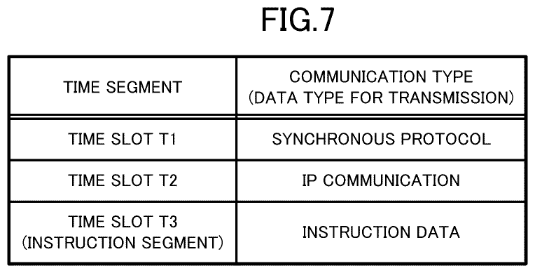

The communication device 100 including the transmission module 533 broadcasts the instruction data in a time slot T3, as illustrated in FIG. 6. The time slot T3 is a time segment for transmitting instruction data, as illustrated in FIG. 7. The time slot T3 immediately precedes the time slot T1 in which a buffering process is to occur when the second data is transmitted. This time segment is hereafter referred to as an instruction segment as appropriate. In the instruction segment, a TSN-compliant device does not transmit data that differs from instruction data. Upon receiving instruction data, a TSN-compliant device continues communication in accordance with the TSN standards without suspending transmission of data in accordance with the instruction data.

Referring back to FIG. 6, upon receiving instruction data through the relay device 130, the second device 120 suspends transmission of second data in accordance with the received instruction data. The second device 120 immediately suspends transmission of the second data upon receiving the instruction data. Thus, the start time to suspend transmission of the second data substantially coincides with the time when the instruction data is received. A time length TL1 for which transmission is suspended is equal to the sum of the time length of the time slot T3 and the time length of the time slot T1. The second device 120 starts transmitting the second data after the time length TL1 elapses from when the instruction data is received. The time to start such transmission is within the time slot T2 corresponding to the second data. Thus, the relay device 130 and the communication device 100 relay the second data to the first device 110 without buffering the second data.

The transmission module 533 corresponds to an example of transmission means for transmitting, to the second device, instruction data to specify the length of time for which transmission of the second data is suspended to instruct the second device to suspend transmission of the second data in an instruction segment included in the time segments in the communication device 100. The instruction segment is a time segment for transmitting the instruction data.

Referring back to FIG. 5, the first device 110 includes a storage 111 that stores various sets of data, and a communicator 112 that communicates with other devices. The second device 120 includes a storage 121 that stores various sets of data, and a communicator 122 that communicates with other devices. The relay device 130 incudes a storage 131 that stores data to be temporarily held in relaying and other data, and a communicator 132 that communicates with other devices. The communicators 112 and 132 in the first device 110 and the relay device 130 that are TSN-compliant devices have the same functions as the reception module 531, the relay module 532, and the communication module 534 in the communication device 100.

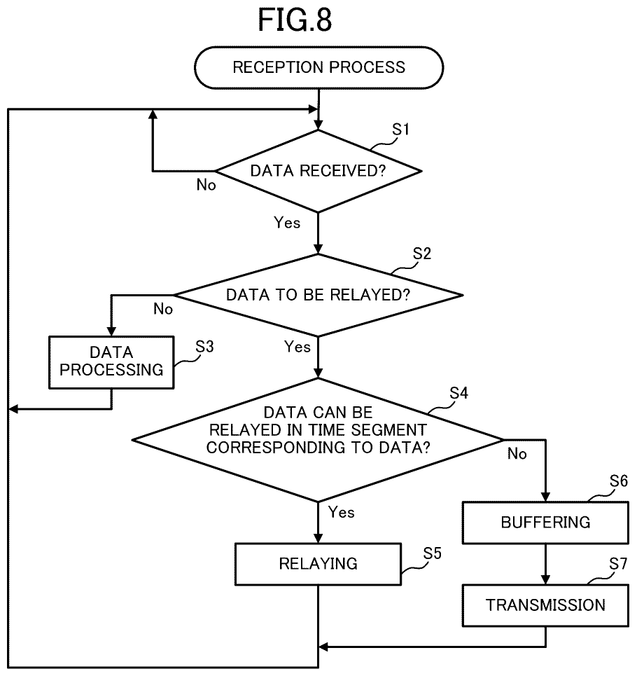

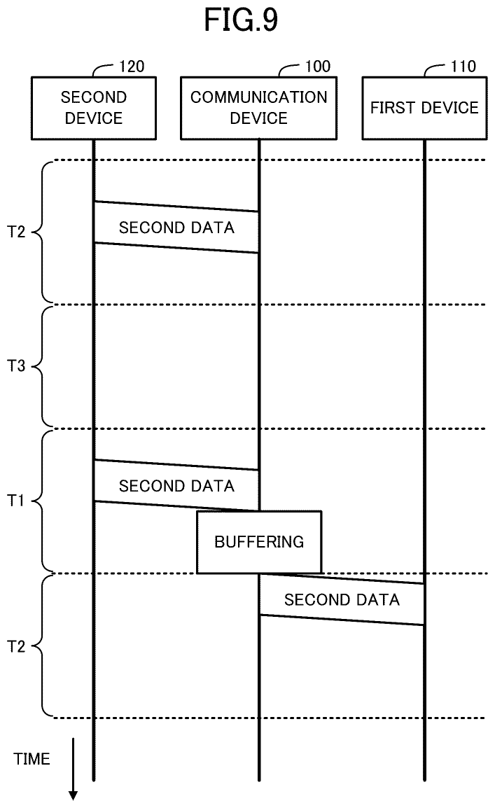

A process performed by the communication device 100 is described with reference to FIGS. 8 and 9. FIG. 8 illustrates a reception process performed by the communication device 100 to receive and process second data transmitted from the second device 120.

As illustrated in FIG. 8, the communication device 100 determines whether data has been received in the reception process (step S1). More specifically, the reception module 531 in the communicator 53 determines whether data transmitted from another device has been received.

When no data has been received (No in step S1), the determination in step S1 is repeated. When data has been received (Yes in step S1), the reception module 531 determines whether the received data is to be relayed (step S2). When the destination of the data received by the communication device 100 from the second device 120 includes the first device 110, the result of determination in step S2 is affirmative.

When the data is not to be relayed (No in step S2), the reception module 531 performs data processing on the received data that is directed to the communication device 100 (step S3). More specifically, the reception module 531 stores the received data into the storage 52 for the controller 51 to process the received data. The communication device 100 then repeats the processing in step S1 and subsequent steps.

When the data is to be relayed (Yes in step S2), the relay module 532 determines whether the data can be relayed in the time segment corresponding to the data (step S4). When the data is second data transmitted from the second device 120 to the first device 110 with IP communication, the relay module 532 determines whether the second data can be transmitted to the first device 110 in the time slot T2 for IP communication. More specifically, the relay module 532 determines whether a point in time at which the time taken for the relay processing performed internally by the communication device 100 elapses from the current time is included in the time slot T2 for IP communication predefined by the shared time.

When the data can be relayed in the corresponding time segment (Yes in step S4), the relay module 532 performs a relay process (step S5). The relay module 532 relays, for example, the second data that is determined to have been received in step S2 by transmitting the second data to the first device 110. The communication device 100 then repeats the processing in step S1 and subsequent steps.

When the data cannot be relayed in the corresponding time segment (No in step S4), the relay module 532 performs a buffering process (step S6). More specifically, the relay module 532 temporarily stores the data determined to have been received in step S2 into the storage 52.

The relay module 532 performs a transmission process (step S7). More specifically, the relay module 532 reads the data from the storage 52 and transmits the data to the destination device in the time segment corresponding to the data buffered in step S6. For example, the relay module 532 transmits the buffered second data to the first device 110 in the time slot T2. The communication device 100 then repeats the processing in step S1 and subsequent steps.

In the communication system 1000 with the configuration illustrated in FIG. 1, the relay device 130 mainly buffers and relays the second data transmitted from the second device 120 at any time. Thus, the same reception process as illustrated in FIG. 8 is performed by the relay device 130. In the communication system 1000 eliminating the relay device 130, the communication device 100 may perform the reception process described above to buffer the second data transmitted at any time as illustrated in FIG. 9 before relaying the second data in accordance with the TSN standards. When either the communication device 100 or the relay device 130 that mainly performs buffering receives a large amount of second data in a time segment in which second data cannot be transmitted, a large amount of data to be buffered may exceed the buffer capacity.

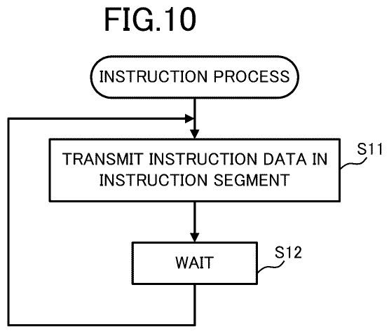

An instruction process performed by the communication device 100 for transmitting instruction data is described below with reference to FIG. 10. As illustrated in FIG. 10, the transmission module 533 transmits instruction data in an instruction segment in the instruction process (step S11). More specifically, the transmission module broadcasts instruction data including the sum of the time length of the instruction segment and the time length of the next time segment as a specified value indicating the time when transmission of data is to be suspended. The transmission module 533 may transmit the instruction data to the second device 120 that is not compliant with the TSN standards without broadcasting the data.

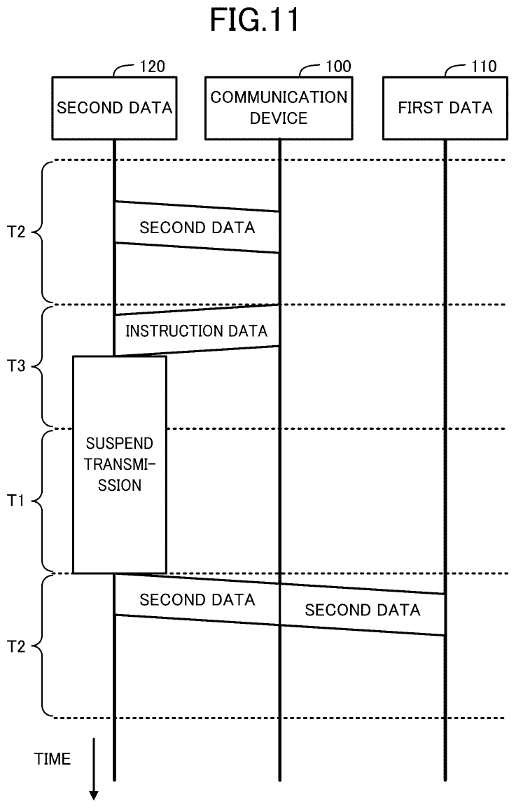

The transmission module 533 then waits in a time segment different from the instruction segment (step S12). The transmission module 533 then repeats the processing in step S11 and subsequent steps. In the communication system 1000 eliminating the relay device 130, the transmission module 533 in the communication device 100 may suspend transmission of the second data in the time slot T1 by transmitting instruction data to the second device 120 as illustrated in FIG. 11.

As described above, the transmission module 533 transmits the instruction data to the second device 120 in the instruction segment, and the length of time specified by the instruction data is equal to the sum of the length of the instruction segment and the length of the time slot T1 immediately following the instruction segment. The time slot T2 corresponding to the second data immediately follows the time slot T1. The time slot T1 is a time segment corresponding to a type of data different from the type of second data. Thus, buffering is performed when the second device 120 transmits the second data in the time slot T1. However, the second device 120 suspends transmission of the second data in accordance with the instruction data in the time slot T1 and can transmit the second data in the time slot T2. This avoids an excess load caused by temporarily holding the second data for transmission in an appropriate time segment in the device that relays the second data. The communication device can thus reduce data loss in the network including both a communication device with time-division communication capabilities and a device without time-division communication capabilities.

Although a time segment is defined for communication between TSN-compliant devices, the structure according to the present embodiment uses an instruction segment to receive second data from devices that are not compliant with the TSN standards in the time segment corresponding to the second data. The communication device 100 transmitting instruction data within the time segment together with other data before the time slot T1 without an instruction segment may not easily use a predetermined time to transmit the instruction data. In this case, the time when the second device 120 suspends transmission of data in accordance with the instruction data may not or may merely slightly coincide with the time segment in which buffering occurs when the second data is transmitted.

In contrast, the structure according to the present embodiment uses an instruction segment for transmitting instruction data and thus can transmit instruction data at a predetermined time for each periodic instruction segment independently of other data being transmitted.

### Embodiment 2

Embodiment 2 is described focusing on the differences from Embodiment 1. The same reference signs denote the components that are the same as or similar to those in Embodiment 1. In Embodiment 1 described above, as illustrated in FIG. 6, the time when the second device 120 starts transmitting the second data after the second device 120 suspends transmission of the second data is within the time slot T2 corresponding to the second data, but the transmission of the second data is disabled in an initial portion of the time slot T2. More specifically, the data transmission is suspended although the second data can be transmitted. The present embodiment differs from Embodiment 1 in that the second device 120 transmits the second data from the start of the time slot T2. In the example described below, the length of time for which data transmission is suspended is determined based on a transmission delay.

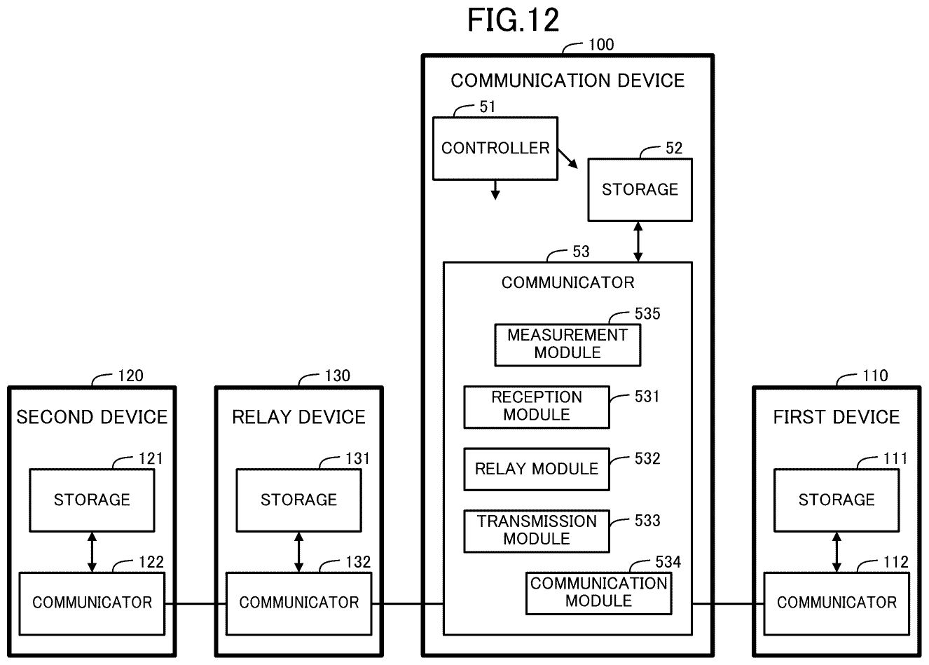

The communicator 53 in the communication device 100 according to the present embodiment includes a measurement module 535 that measures a transmission delay of data transmitted to and from the second device 120 as illustrated in FIG. 12.

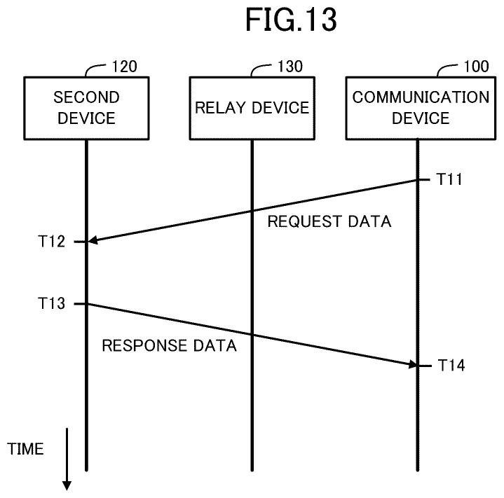

FIG. 13 illustrates an overview of measurement of a transmission delay performed by the measurement module 535. As illustrated in FIG. 13, the communication device 100 including the measurement module 535 transmits, to the second device 120 at a time T11, request data requesting a response from the second device 120 to measure a transmission delay. The request data is received by the second device 120 at a time T12.

Upon receiving the request data, the second device 120 responds to the communication device 100 by transmitting response data to the communication device 100. The response data is information indicating the time T12 at which the request data is received and the time T13 at which the response data is transmitted.

When the communication device 100 receives the response data, the measurement module 535 calculates a transmission delay D with Formula 1 below using the time T11 at which the request data is transmitted, the times T12 and T13 indicated by the response data, and the time T14 at which the response data is received.

D=((T14−T11)−(T13−T12))/2 (1)

The request data and the response data may be transmitted in the corresponding time segments.

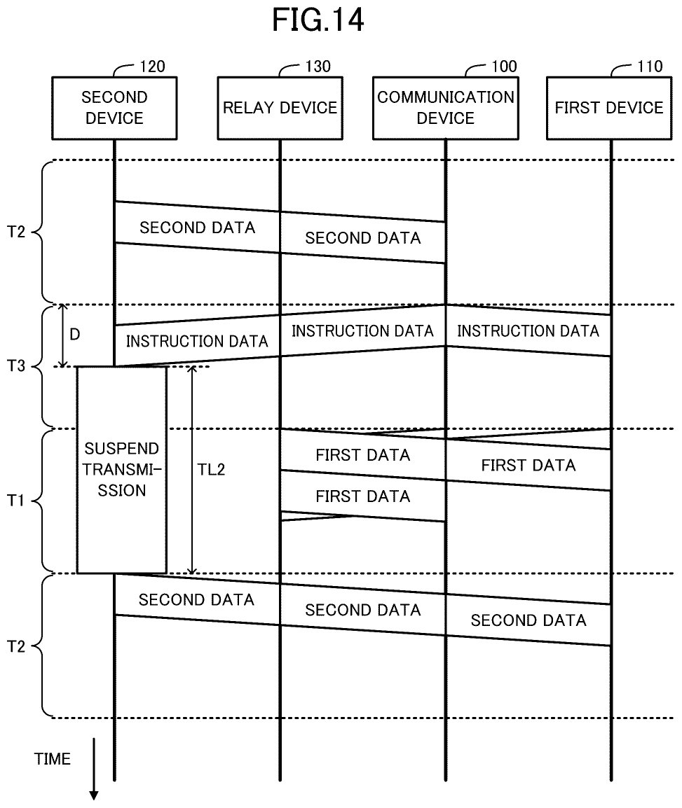

The transmission module 533 calculates a specified value for the time when data transmission is to be suspended based on the transmission delay measured by the measurement module 535, and transmits instruction data including the calculated specified value to the second device 120. An example of this specified value is illustrated as a time length TL2 in FIG. 14. The time length TL2 is equal to the difference acquired by subtracting the transmission delay D from the sum of the time length of the time slot T3 being the instruction segment and the time length of the time slot T1 being the time slot next to the instruction segment.

The instruction segment is a time segment for transmitting instruction data, in which no other types of data are transmitted. The communication device 100 transmits instruction data immediately after the start of the instruction segment. After receiving the instruction data, the second device 120 suspends transmission of data for the time length TL2 before transmitting the second data.

As described above, the length of time specified by the instruction data is equal to the difference acquired by subtracting the transmission delay of the instruction data from the sum of the length of the instruction segment and the length of the time segment next to the instruction segment. The end time of the period for which the second device 120 suspends transmission of the second data coincides with the end time of the time segment following the instruction segment and not corresponding to the second data. This allows the second device 120 to transmit the second data immediately after the start of the time segment intended for the second data.

The communication device 100 may appropriately adjust the time length for which data transmission is suspended by alternately repeating measurement of a transmission delay performed by the measurement module 535 and transmission of instruction data based on the measured transmission delay. For example, such time length adjustment is useful when different transmission delays occur during daytime and nighttime.

Although the measurement of an example transmission delay performed by the measurement module 535 is described, the embodiment is not limited to this. In some embodiments, the time length to suspend data transmission may be determined based on the estimated value of a transmission delay input by the user.

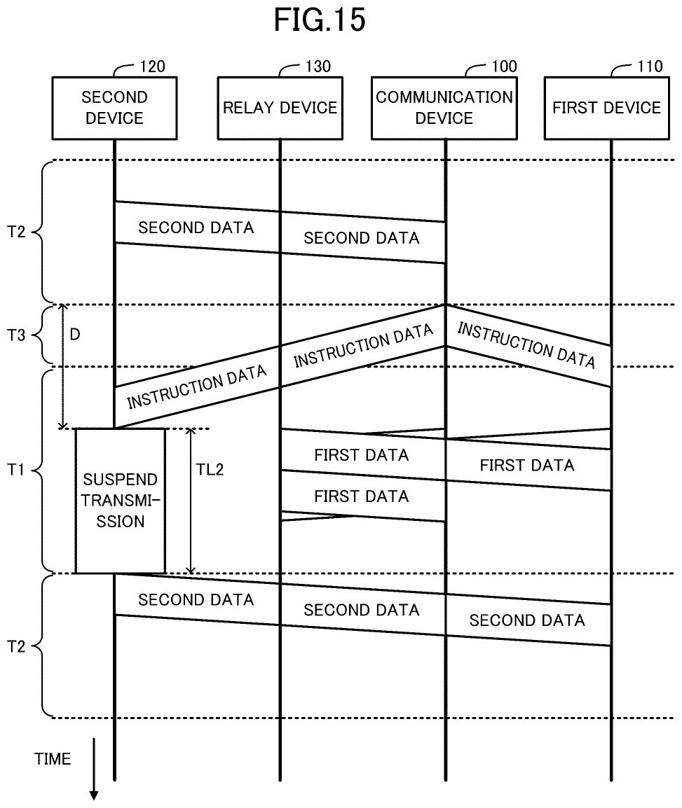

The length of the time slot T3 as the instruction segment may be less than the transmission delay of the instruction data. For example, as illustrated in FIG. 15, instruction data may be relayed and received in a time segment later than the time slot T3 for transmitting instruction data. In an instruction segment, transmission of any type of data other than instruction data is disabled. The length of the instruction segment may thus be short. When the length of the instruction segment is less than the transmission delay of the instruction data, the first data can be transmitted by a TSN-compliant device in a relatively short time after the instruction data is transmitted by the communication device 100.

For the first data and the second data, the transmission may be complete in a time segment corresponding to the data type, or more specifically, the transmission, relay, and reception may be complete in the corresponding time segment. However, the embodiment is not limited to this. The time slot T1 for transmitting the first data may not include reception of the first data being complete. Similarly, the time slot T2 for transmitting the second data may not include reception of the second data being complete.

In the example in FIG. 15, the second device 120 can transmit the second data immediately after the start of the time slot T1 until the instruction data is received. This can cause buffering performed by the relay device 130 and the communication device 100. However, during a period after the instruction data is received, the second device 120 suspends transmission of the second data, thus preventing buffering in this period. This further reduces data loss. Thus, the period for which transmission of the second data by the second device 120 is suspended in accordance with the instruction data may include a part of the time segment immediately following the instruction segment. More specifically, the length of time specified by the instruction data may be at least the length of time from when the second device 120 suspends transmission of the second data to when at least a part of the time segment immediately following the instruction segment and preceding the second data segment elapses.

### Embodiment 3

Embodiment 3 is described focusing on the differences from Embodiment 1. The same reference signs denote the components that are the same as or similar to those in Embodiment 1. The present embodiment differs from Embodiment 1 in that the time when the transmission of the second data by the second device 120 is resumed is included in the time segment immediately preceding the time slot T2.

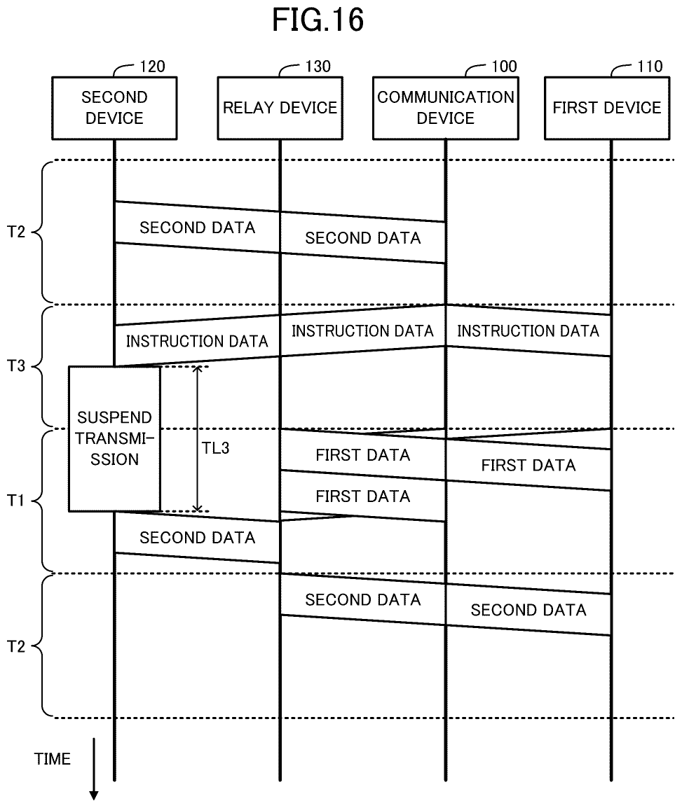

In the example illustrated in FIG. 16, the communication device 100 transmits instruction data immediately after the start of the time slot T3, and a time length TL3 specified by this instruction data is equal to the length of the time slot T1. In this example, the second device 120 in the time slot T1 transmits the second data. However, with transmission of the second data suspended for most of the time slot T1, the amount of second data to be buffered decreases greatly and reduces data loss.

Thus, the time when transmission of the second data by the second device 120 is resumed may be included in the time slot T2 as in Embodiments 1 and 2 or may be included in the time slot T1 immediately preceding the time slot T2 as in the present embodiment. In other words, the length of time specified by the instruction data may be equal to the length of time from when the second device 120 suspends transmission of the second data to the time included in the time slot T2 as illustrated in FIG. 6, or to the time included in the time segment immediately preceding the time slot T2 as illustrated in FIG. 16.

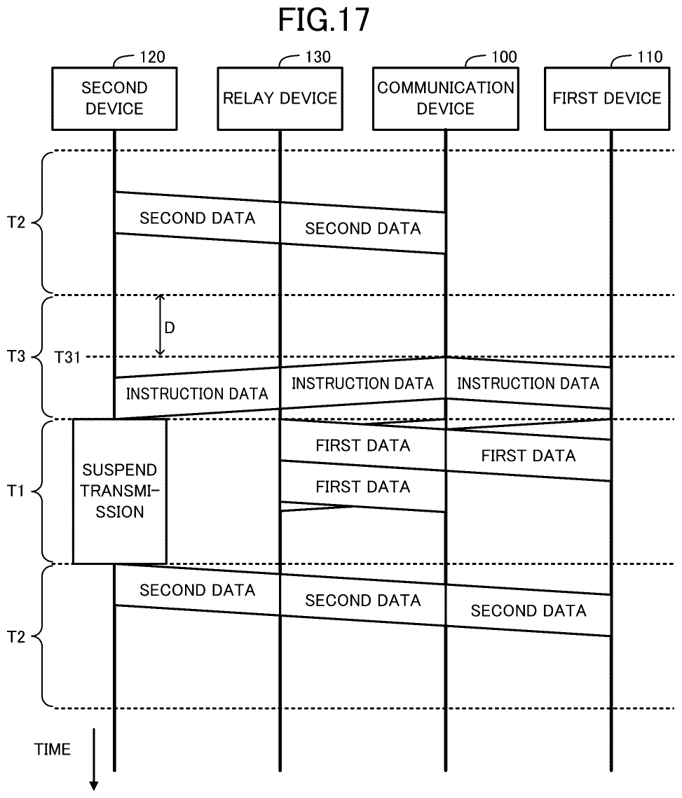

As illustrated in FIG. 17, when the transmission module 533 in the communication device 100 transmits the instruction data at the time T31 preceding the end of the time slot T3 by a transmission delay D, the second device 120 suspends transmission of the second data simply during the time slot T1. The time T31 may be determined based on the transmission delay measured by the measurement module 535 in Embodiment 2, or the time T31 may be specified by a parameter input by the user.

### Embodiment 4

Embodiment 4 is described focusing on the differences from Embodiment 1. The same reference signs denote the components that are the same as or similar to those in Embodiment 1. The present embodiment differs from Embodiment 1 in that the second device 120 is to suspend transmission of the second data in multiple consecutive time segments.

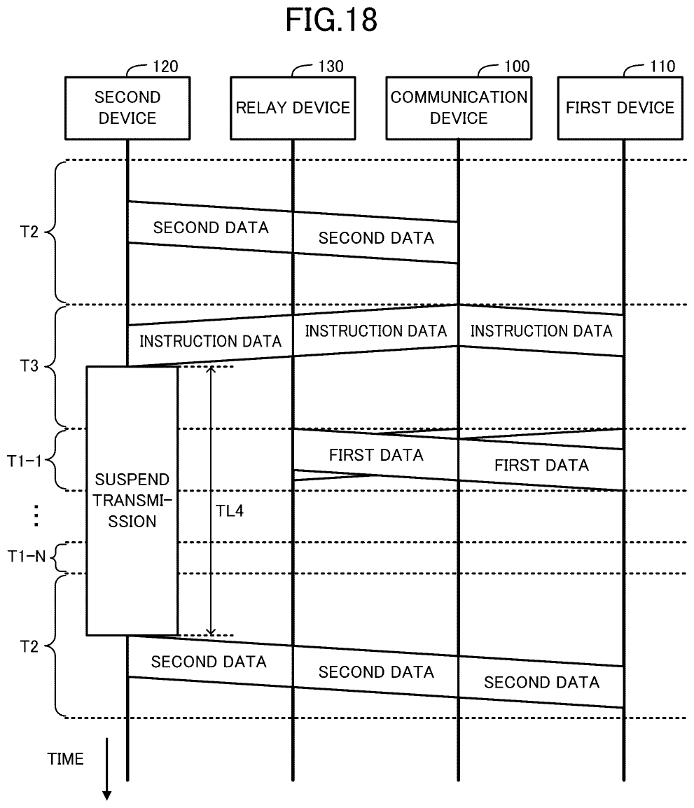

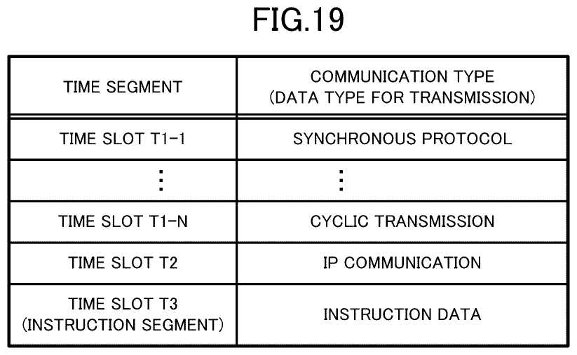

FIG. 18 is a diagram illustrating a time length TL4 specified by instruction data in the present embodiment. The time length TL4 is a length of multiple consecutive time segments, including a time slot T1-1 immediately following the time slot T3 as the instruction segment to a time slot T1-N immediately preceding the time slot T2 as the time segment corresponding to the second data. In the time slot T1-N, data for cyclic transmission is transmitted as illustrated in FIG. 19. Cyclic transmission is a communication scheme to synchronize data stored in the memory included in each device in each consecutive cycle by performing communication in cycles to store common data into the memory.

As described above, the length of time specified by the instruction data may be defined by the length of the multiple time segments in which the second device 120 is to suspend transmission of the second data. More specifically, the length of time specified by the instruction data may be equal to the sum of the lengths of multiple consecutive time segments from the time slot T1-1 immediately following the instruction segment to the time slot T1-N immediately preceding the time slot T2 in which the second data transmission is permitted. With the instruction data described above, the second device 120 suspends transmission of the second data in the time segment corresponding to a type of data different from the second data and transmits the second data in the time segment corresponding to the second data.

The time length reflecting a transmission delay may be specified in the present embodiment as in Embodiment 2 described above. More specifically, the length of time specified by the instruction data may be equal to the difference acquired by subtracting the transmission delay from the length of multiple consecutive time segments. As in Embodiment 3 described above, the length of time specified by the instruction data may be equal to the length of multiple consecutive time segments between the instruction segment and the time slot T2. The length of time for which the second device 120 is to suspend transmission of data may be greater than or equal to the length of a no-second data period and less than or equal to the sum acquired by adding the length of the instruction segment to the length of the no-second data period. The no-second data period may include one time segment or multiple consecutive time segments that do not correspond to the second data.

### Embodiment 5

Embodiment 5 is described focusing on the differences from Embodiment 4. The same reference signs denote the components that are the same as or similar to those in Embodiment 4. The present embodiment differs from Embodiment 4 in that the time segment corresponding to the type of second data is included in the period for which the second device 120 suspends data transmission.

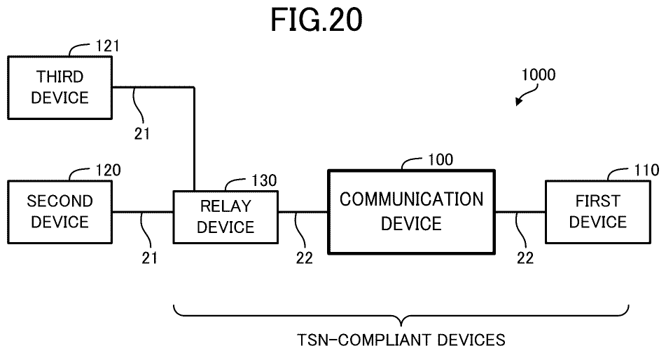

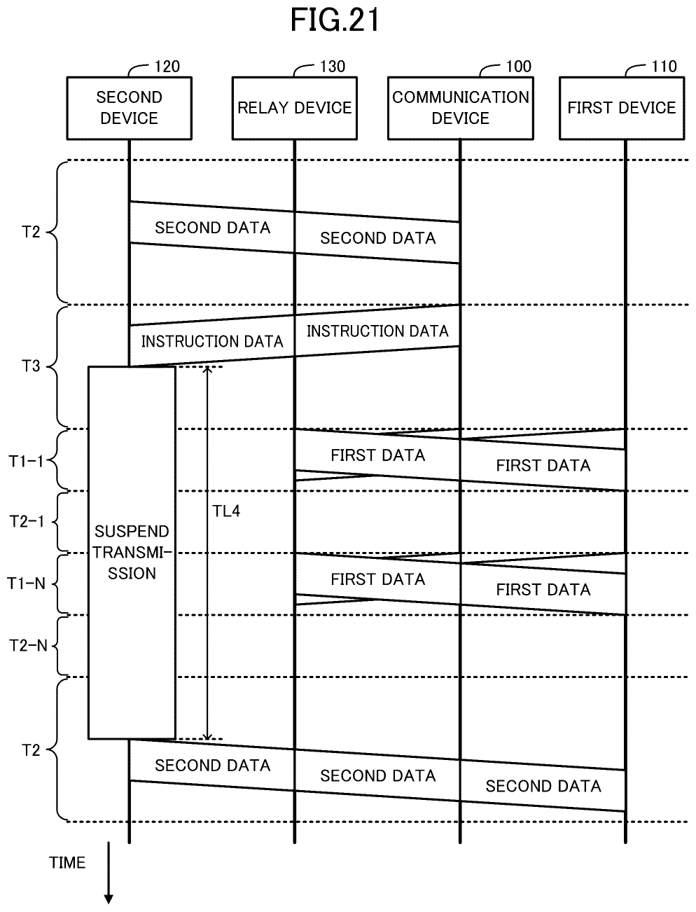

FIG. 20 is a block diagram of a communication system 1000 according to the present embodiment. The communication system 1000 includes a third device 130a that is a TSN-noncompliant device. The third device 130a, similarly to the second device 120, can transmit the second data independently of any time segment. However, the second data transmitted from the third device 130a may allow buffering. As illustrated in FIG. 21, the instruction segment is followed by a time slot

T1-1 corresponding to the first data type, a time slot T2-1 corresponding to the second data type, a T1-N corresponding to the first data type, and a T2-N corresponding to the second data type in this order. The communication device 100 then transmits the instruction data specifying a time length TL4 to the second device 120 in the time slot T3. In FIG. 21, the third device 130a is not illustrated.

The time slot T2-1 and the time slot T2-N are time segments corresponding to the second data. In these time segments, transmission of the second data by the second device 120 is suspended, and transmission of the second data by the third device 130a is not suspended.

As described above, although the period for which transmission of the second data by the second device 120 is suspended includes a time segment corresponding to the type of second data, buffering caused by transmission of the second data by the second device 120 can be reduced to reduce data loss. Thus, all the periods following the instruction segment and preceding the time segment in which transmission of the second data by the second device 120 is permitted may not be time segments corresponding to a type of data different from the type of second data. More specifically, at least one time segment corresponding to a type of data different from the type of second data may follow the instruction segment and may precede the time segment corresponding to the type of second data.

The time slot T1-1 and the time slot T1-N may be eliminated from the example illustrated in FIG. 21. All the periods following the instruction segment and preceding the time segment in which transmission of the second data by the second device 120 is permitted may be time segments corresponding to a type of second data.

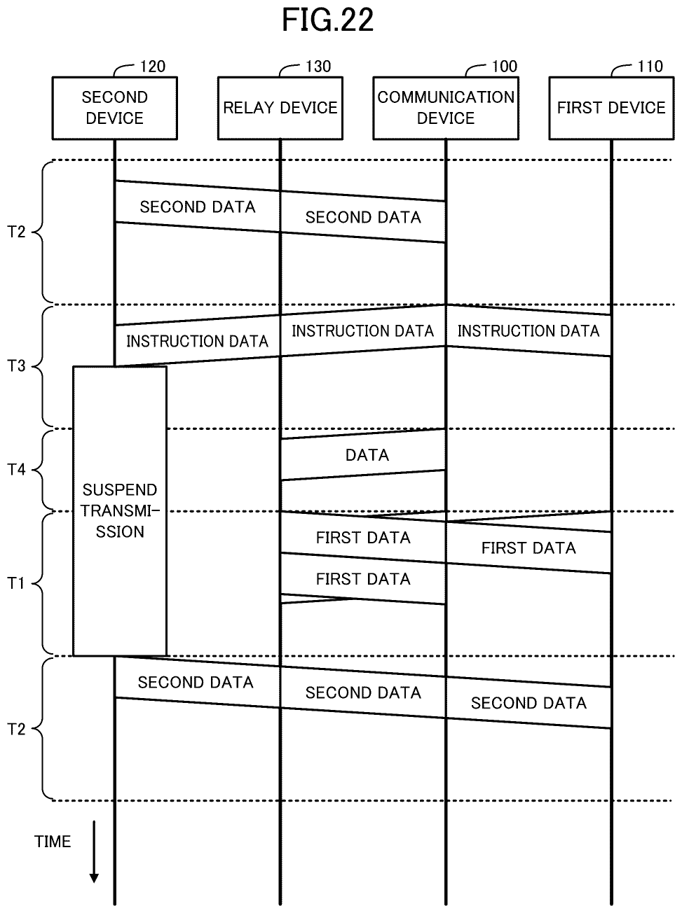

Although the communication system 1000 includes a TSN-noncompliant device in addition to the second device 120, in the example illustrated in FIG. 22, transmission of the second data is suspended in the time slots T4 and T1 following the time slot T3 as the instruction segment.

The time slot T1 is a time segment for a synchronous protocol as in the above embodiments. The time slot T4 corresponds to IP communication. The time slot T4 is a time segment that does not involve buffering based on the correspondence between the time segment and the communication type, but is a time segment in which data transmission from the second device 120 is not intended. In such a time segment, IP communication between TSN-compliant devices is prioritized over second data transmitted from the second device 120.

Although one or more embodiments of the present disclosure have been described above, the present disclosure is not limited to the above embodiments.

In the embodiments described above, for example, the relay module 532 and the communication module 534 are separate components, but the embodiments are not limited to this. The communication module 534 may function as the relay module 532.

The functions of the communication device 100 may be implemented by either dedicated hardware or a common computer system.

For example, the program P1 executable by the processor 31 may be stored in a non-transitory computer-readable recording medium for distribution. The program P1 is installed in a computer to provide a device that performs the processing described above. Examples of such a non-transitory recording medium include a flexible disk, a compact disc read-only memory (CD-ROM), a digital versatile disc (DVD), and a magneto-optical (MO) disk.

The program P1 may be stored in a disk device included in a server on a communication network, typically the Internet, and may be, for example, superimposed on a carrier wave to be downloaded to a computer.

The processing described above may also be performed by the program P1 being activated and executed while being transferred through a communication network.

The above processing may be performed by entirely or partially executing the program P1 on a server device while a computer is transmitting and receiving information on the processing through a communication network.

In the system with the above functions implementable partially by the operating system (OS) or through cooperation between the OS and applications, portions executable by applications other than the OS may be stored in a non-transitory recording medium that may be distributed or may be downloaded to the computer.

Means for implementing the functions of the communication device 100 is not limited to software, and may be partially or entirely implemented by dedicated hardware including a circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is applicable to a communication system in which devices communicate with each other in time segments defined by time shared between the devices.

### REFERENCE SIGNS LIST

1000 Communication system
100 Communication device
110 First device
111, 121, 131 Storage
112, 122, 132 Communicator
120 Second device
130 Relay device
130a Third device
21, 22 Communication channel
30 Network device
31 Processor
32 Main storage
33 Auxiliary storage
34 Clock
35 Input device
36 Output device
37 Communicator
38 Internal bus
41, 42 Period
51 Controller
52 Storage
53 Communicator
531 Reception module
532 Relay module
533 Transmission module
534 Communication module
535 Measurement module
TS1, TS2, T1 to T4, T1-1, T1-N, T2-1, T2-N Time slot
T11 to T41, T31 Time
TL1 to TL4 Time length
P1 Program

1. A communication device for communicating with a first device and a second device, the communication device comprising:
communication circuitry to communicate with the first device by at least transmitting first data to the first device or receiving the first data from the first device in a first data segment included in a plurality of time segments defined by a shared time shared with the first device, the first data segment being a time segment corresponding to a type of the first data;
a receiver to receive second data transmitted from the second device independently of the plurality of time segments;
relay circuitry to relay the second data to be transmitted to the first device in a second data segment included in the plurality of time segments when a destination of the second data received by the receiver includes the first device, the second data segment being a time segment corresponding to a type of the second data; and
a transmitter to transmit in an instruction segment, to the second device, instruction data to specify a length of time for which transmission of the second data is suspended to instruct the second device to suspend transmission of the second data, the instruction segment being included in the plurality of time segments and being a time segment for transmitting the instruction data,
wherein the length of time specified by the instruction data is equal to or greater than a length of time from when the second device suspends transmission of the second data in accordance with the instruction data to when at least a part of a time segment immediately following the instruction segment and preceding the second data segment elapses.

2. The communication device according to claim 1, wherein
the length of time specified by the instruction data is equal to a length of time from when the second device suspends transmission of the second data in accordance with the instruction data to a time included in the second data segment or to a time included in a time segment immediately preceding the second data segment.

3. The communication device according to claim 1, wherein
the plurality of time segments include, following the instruction segment and preceding the second data segment, a time segment corresponding to a type of data different from the type of the second data.

4. The communication device according to claim 1, wherein
the plurality of time segments include a no-second data period immediately following the instruction segment to immediately preceding the second data segment, and the no-second data period includes one time segment or a plurality of consecutive time segments corresponding to a type of data different from the type of the second data, and
the length of time specified by the instruction data is greater than or equal to a length of the no-second data period and less than or equal to a sum of a length of the instruction segment and a length of the no-second data period.

5. The communication device according to claim 4, wherein
the length of time specified by the instruction data is equal to a difference acquired by subtracting, from the sum of the length of the instruction segment and the length of the no-second data period, a transmission delay in transmitting data from the communication device to the second device.

6. A communication method to be implemented with a communication device for communicating with a first device and a second device, the communication method comprising:
communicating with the first device by at least transmitting first data to the first device or receiving the first data from the first device in a first data segment included in a plurality of time segments defined by a shared time shared with the first device, the first data segment being a time segment corresponding to a type of the first data;
receiving second data transmitted from the second device independently of the plurality of time segments;
relaying the second data to be transmitted to the first device in a second data segment included in the plurality of time segments when a destination of the received second data includes the first device, the second data segment being a time segment corresponding to a type of the second data; and
transmitting in an instruction segment, to the second device, instruction data to specify a length of time for which transmission of the second data is suspended to instruct the second device to suspend transmission of the second data, the instruction segment being included in the plurality of time segments and being a time segment for transmitting the instruction data,
wherein the length of time specified by the instruction data is equal to or greater than a length of time from when the second device suspends transmission of the second data in accordance with the instruction data to when at least a part of a time segment immediately following the instruction segment and preceding the second data segment elapses.

7. A non-transitory recording medium storing a program, the program causing a computer for communicating with a first device and a second device to perform operations comprising:
communicating with the first device by at least transmitting first data to the first device or receiving the first data from the first device in a first data segment included in a plurality of time segments defined by a shared time shared with the first device, the first data segment being a time segment corresponding to a type of the first data;
receiving second data transmitted from the second device independently of the plurality of time segments;
relaying the second data to be transmitted to the first device in a second data segment included in the plurality of time segments when a destination of the received second data includes the first device, the second data segment being a time segment corresponding to a type of the second data; and
transmitting in an instruction segment, to the second device, instruction data to specify a length of time for which transmission of the second data is suspended to instruct the second device to suspend transmission of the second data, the instruction segment being included in the plurality of time segments and being a time segment for transmitting the instruction data,
wherein the length of time specified by the instruction data is equal to or greater than a length of time from when the second device suspends transmission of the second data in accordance with the instruction data to when at least a part of a time segment immediately following the instruction segment and preceding the second data segment elapses.
